(19) United States
(12) Patent Application Publication
(10) Pub. No.: US 2014/0164310 A1
(43) Pub. Date: Jun. 12, 2014

(54) COMMUNICATION SYSTEM WITH AGENT ASSISTANCE MECHANISM AND METHOD OF OPERATION THEREOF

(71) Applicant: Samsung Electronics Co., Ltd., Gyeonggi-do (KR)

(72) Inventors: Guangshun Chen, Saratoga, CA (US); Kuldip S. Pabla, San Jose, CA (US); Curtis Jyun Sasaki, Sunnyvale, CA (US)

(73) Assignee: Samsung Electronics Co., Ltd., Gyeonggi-Do (KR)

(21) Appl. No.: 13/967,154

(22) Filed: Aug. 14, 2013

Related U.S. Application Data
(60) Provisional application No. 61/735,866, filed on Dec. 11, 2012.

(51) Int. Cl. G06N 5/02

(52) U.S. Cl. CPC G06N 5/025
USPC 706/47

(57) ABSTRACT

A method of operation of a navigation system includes: establishing a recipient response rule for access to a recipient information with a control unit; adjusting the recipient response rule based on a recipient context; processing a task request to access the recipient information based on the recipient response rule; and generating a recipient response to the task request for displaying on a device of the request sender.

### CROSS-REFERENCE TO RELATED APPLICATION(S)

This application claims the benefit of U.S. Provisional Patent Application Ser. No. 61/735,866 filed Dec. 11, 2012, and the subject matter thereof is incorporated herein by reference thereto.

### TECHNICAL FIELD

An embodiment of the present invention relates generally to a communication system, and more particularly to a system for agent assistance.

### BACKGROUND

Modern consumer and industrial electronics, especially client devices such as navigation systems, cellular phones, portable digital assistants, and combination devices, are providing increasing levels of functionality to support modern life including location-based information services. Research and development in the existing technologies can take a myriad of different directions.

As users become more empowered with the growth of information transfer based service devices, new and old paradigms being to take advantage of this new device space. There are many technological solutions to take advantage of this new device information transfer opportunity. One existing approach is to use information transfer to provide up to date or real-time information about friends or other device users of a mobile device such as a cell phone, smart phone device, a personal digital assistant (PDA), or a computing system, including a personal computer, tablet computer, or a smart television.

Communication systems and information transfer systems have been incorporated in automobiles, notebooks, handheld devices, and other portable products. Today, these systems aid users by incorporating available, personal information of the user and real-time relevant information, such as personal preferences of the user, identification information, contact information, and scheduling information. Real-time access provides invaluable relevant information.

However, user agent assisted communication that includes real-time context and information has become a paramount concern for the consumer. Standard information transfer and exchange provided by communication systems may be inefficient and not up to date, decreasing the benefit of using the tool.

Thus, a need still remains for a communication system with agent assistance mechanism to exchange information that is the most useful to the user. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a communication system, including: a rule initiation module configured to establish a recipient response rule for access to a recipient information with a control unit; a rule modification module, coupled to the rule initiation module, configured to adjust the recipient response rule based on a recipient context; a task execution module, coupled to the rule modification module, configured to process a task request to access the recipient information based on the recipient response rule; and a response generation module, coupled to the task execution module, configured to generate a recipient response to the task request for displaying on a device of the task sender.

An embodiment of the present invention provides a method of operation of a communication system including: establishing a recipient response rule for access to a recipient information with a control unit; adjusting the recipient rule based on a recipient context; processing a task request to access the recipient information based on the recipient response rule; and generating a recipient response to the task request for displaying on a device of the task sender.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a communication system with agent assisted communication in an embodiment of the present invention.

FIG. 2 is an example of the first device of FIG. 1.

FIG. 3 is an exemplary block diagram of the navigation system.

FIG. 4 is a control flow of the communication system.

FIG. 5 is a view of the request process module.

FIG. 6 is an example implementation of the communication system.

FIG. 7 is a flow chart of a method of operation of a communication system in an embodiment of the present invention.

### DETAILED DESCRIPTION

An embodiment of the present invention includes a communication system provides users a method of automatic exchange of information between devices or execution of tasks without direct involvement of the device users. The communication system can maintain varying degrees of access to information about the user to protect user privacy. The access to information can be dynamically changed or adjusted based on the context of the user with our without direct input by the user.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

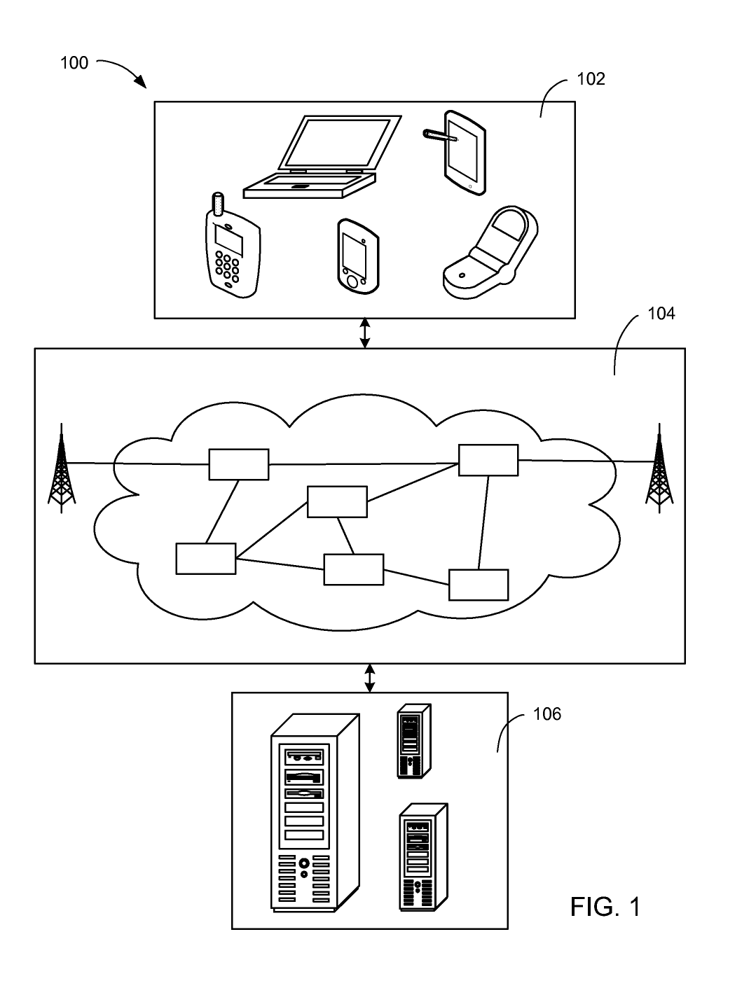

Referring now to FIG. 1, therein is shown a communication system 100 with agent assisted communication in an embodiment of the present invention. The communication system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, a web-enabled or smart phone, personal digital assistant, a tablet computer, a notebook computer, a liquid crystal display (LCD) system, a smart television, or other multi-functional display or entertainment device. The first device 102 can couple, either directly or indirectly, to the communication path 104 to communicate with the second device 106 or can be a stand-alone device.

For illustrative purposes, the communication system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, an internet based storage system, or information transmission devices. For example, the second device 106 can be a multimedia computer, a laptop computer, a desktop computer, grid-computing resources, a virtualized computer resource, cloud computing resource, routers, switches, peer-to-peer distributed computing devices, or a combination thereof.

The second device 106 can be centralized in a single room, distributed across different rooms, distributed across different geographical locations, embedded within a telecommunications network. The second device 106 can couple with the communication path 104 to communicate with the first device 102.

For illustrative purposes, the communication system 100 is described with the second device 106 as a computing device, although it is understood that the second device 106 can be different types of devices. Also for illustrative purposes, the communication system 100 is shown with the second device 106 and the first device 102 as end points of the communication path 104, although it is understood that the communication system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

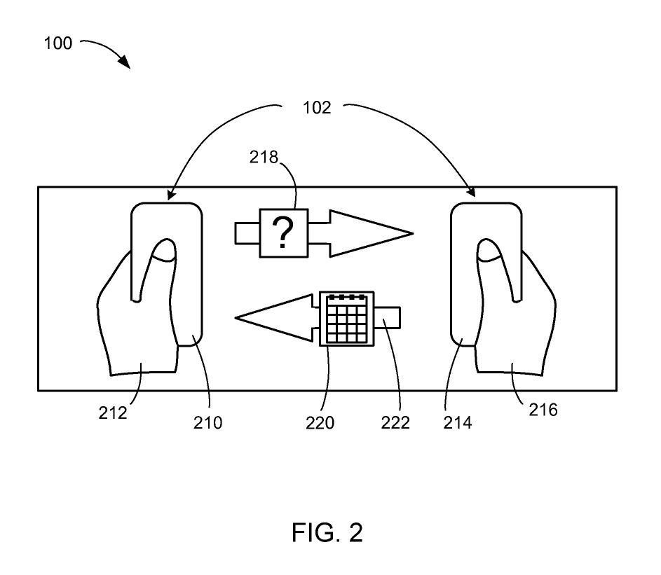

Referring now to FIG. 2, therein is shown an example of the first device 102 of FIG. 1. FIG. 2 depicts a first instance of the first device 102 interacting with a second instance of the first device 102. For example, the first instance of the first device 102 can be a request sender device 210, operated by a request sender 212, and the second instance of the first device 102 can be a request receiver device 214, operated by a request recipient 216. The request sender 212 can initiate a task request 218 through the request sender device 210.

The task request 218 is request for information from or action by another device. For example, the task request 218 can be a request for action, such as a request to schedule a meeting with the request recipient 216. As a specific example, the task request 218 to schedule the meeting can include a request to adjust the schedule of the request recipient 216, to view the appointments and activities on the calendar of the request recipient 216, or a request to schedule the meeting for a specific time period.

In a further example, the task request 218 can be a request to access recipient information 220 of the request recipient 216. The recipient information 220 is information about or related to the recipient of the request. For example, the recipient information 220 can include private or confidential information of the request recipient 216, such as for identification information, including social security information or credit card numbers, or confidential business information. In another example, the recipient information 220 can include scheduling information, such as for appointment information, or contact information for of others in a contact list of the request recipient 216. In a further example, the recipient information 220 can include preferences of the request recipient 216, such as the favorite color, team, or foods, recommended restaurants or retail shops, or the current location of the request recipient 216.

The request receiver device 214 can process the task request 218 and provide a recipient response 222. The recipient response 222 is a response providing affirmative or negative action to the request by the recipient of the request. For example, when the task request 218 is approved, the recipient response 222 can include the recipient information 220. To further the example, when the task request 218 is declined or rejected, the recipient response 222 can include a response states that the task request 218 has been rejected.

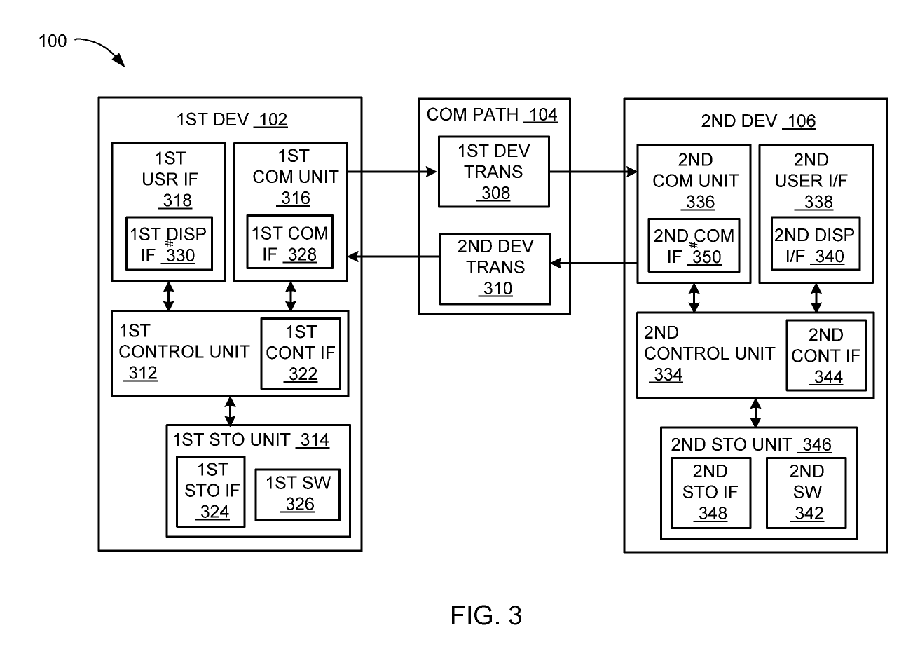

Referring now to FIG. 3, therein is shown an exemplary block diagram of the communication system 100. The communication system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the communication system 100 is shown with the first device 102 as a client device, although it is understood that the communication system 100 can have the first device 102 as a different type of device. For example, the first device 102 can be a server having a display interface.

Also for illustrative purposes, the communication system 100 is shown with the second device 106 as a server, although it is understood that the communication system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 312, a first storage unit 314, a first communication unit 316, and a first user interface 318. The first control unit 312 can include a first control interface 322. The first control unit 312 can execute a first software 326 to provide the intelligence of the communication system 100.

The first control unit 312 can be implemented in a number of different manners. For example, the first control unit 312 can be a processor, an application specific integrated circuit (ASIC) an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations external to the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The first storage unit 314 can store the first software 326. The first storage unit 314 can also store the relevant information, such as data representing incoming images, data representing previously presented image, sound files, or a combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106 of FIG. 1, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user to interface and interact with the first device 102. The first user interface 318 can include an input device and an output device. Examples of the input device of the first user interface 318 can include a keypad, a touchpad, soft-keys, a keyboard, camera, video recorder, a microphone, an infrared sensor for receiving remote signals, or any combination thereof to provide data and communication inputs.

The first user interface 318 can include a first display interface 330. The first display interface 330 can include a display, a projector, a video screen, a speaker, or any combination thereof.

The first control unit 312 can operate the first user interface 318 to display information generated by the communication system 100. The first control unit 312 can also execute the first software 326 for the other functions of the communication system 100. The first control unit 312 can further execute the first software 326 for interaction with the communication path 104 via the first communication unit 316.

The second device 106 can be optimized for implementing an embodiment of the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second device 106 of the communication system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the communication system 100, including operating the second communication unit 336 to communicate with the first device 102 over the communication path 104.

The second control unit 334 can be implemented in a number of different manners. For example, the second control unit 334 can be a processor, an embedded processor, a microprocessor, hardware control logic, a hardware finite state machine (FSM), a digital signal processor (DSP), or a combination thereof.

The second control unit 334 can include a second controller interface 344. The second controller interface 344 can be used for communication between the second control unit 334 and other functional units in the second device 106. The second controller interface 344 can also be used for communication that is external to the second device 106.

The second controller interface 344 can receive information from the other functional units or from external sources, or can transmit information to the other functional units or to external destinations. The external sources and the external destinations refer to sources and destinations external to the second device 106.

The second controller interface 344 can be implemented in different ways and can include different implementations depending on which functional units or external units are being interfaced with the second controller interface 344. For example, the second controller interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the such as data representing incoming images, data representing previously presented image, sound files, or a combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the communication system 100 is shown with the second storage unit 346 as a single hierarchy storage system, although it is understood that the communication system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to the second device 106.

The second storage interface 348 can include different implementations depending on which functional units or external units are being interfaced with the second storage unit 346. The second storage interface 348 can be implemented with technologies and techniques similar to the implementation of the second controller interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second controller interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The communication system 100 can be executed by the first control unit 312, the second control unit 334, or a combination thereof. For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the communication system 100 is described by operation of the first device 102 and the second device 106. It is understood that the first device 102 and the second device 106 can operate any of the modules and functions of the communication system 100.

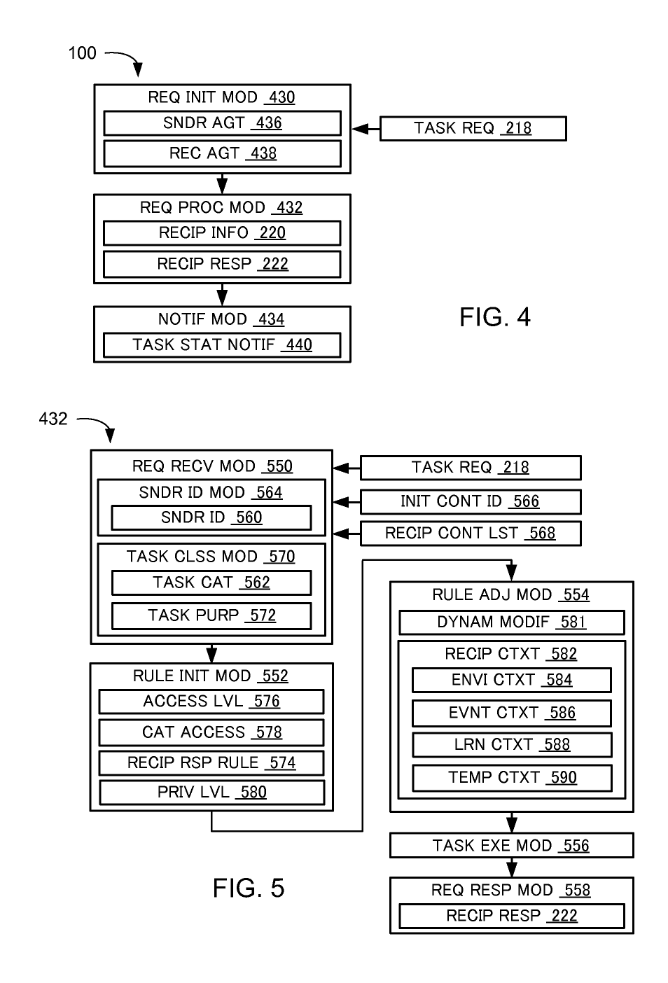

Referring now to FIG. 4, therein is shown a control flow of the communication system 100. The communication system 100 can include a request initiation module 430, a request process module 432, and a notification module 434. The request initiation module 430 can be coupled to the request process module 432. The notification module 434 can be coupled to the request process module 432.

The request initiation module 430 is for initiating a request to obtain information about or related to the recipient of the request. The request initiation module 430 can receive the task request 218 from the request sender 212 of FIG. 2. For example, the request sender 212 can input the task request 218 into the request sender device 210 of FIG. 2 through the first user interface 318 of FIG. 3.

The request initiation module 430 can initiate the task request 218 with a sender agent 436. The sender agent 436 is an assistant that acts on behalf of a user to exchange information or coordinate tasks with agents on other devices. For example, when the request sender 212 inputs the task request 218 into the request sender device 210, the sender agent 436 can determine the contact information of the request recipient 216 and transmit the task request 218 to the request sender device 214.

The request sender device 214 can include a recipient agent 438. The recipient agent 438 is an assistant that acts on behalf of a user to receive and processing requests received from another device. For example, the recipient agent 438 can process the task request 218 received from the sender agent 436 of the request sender device 210. As a specific example, the recipient agent 438 can provide the recipient information 220 to the request sender device 210 in response to the task request 218.

The recipient agent 438 and the sender agent 436 can be authorized to operate without input or interaction with the request sender 212 and the request recipient 216, respectively, to process the task request 218. For example, the recipient agent 438 can interact directly with the sender agent 436 to coordinate events or activities automatically on behalf of the request sender 212 and the request recipient 216. Direct interaction between the recipient agent 438 and the sender agent 436 can be a direct transmission of the task request 218 from the sender agent 436 to the recipient agent 438 through a communication network.

As an example, the request initiation module 430 can direct the sender agent 436 to transmit the task request 218 by indirect interaction when the sender agent 436 is unable to connect or interface directly with recipient agent 438. Indirect interaction between the recipient agent 438 and the sender agent 436 can occur when the sender agent 436 is unable to interact directly with the recipient agent 438 and the sender agent 438 transmits the task request 218 to the recipient agent 438 indirectly. As a specific example, the sender agent 436 can indirectly interact with the recipient agent 438 by sending a recipient message to the request recipient 216, such as through e-mail, short message service, or a pre-defined protocol and format preferred by the request recipient 216. To continue the example, the recipient agent 438 can scan or monitor for the recipient message to receive the task request 218.

The request process module 432 is for receiving the request from another device, determining the identification of the sender of the request, establishing rules for determining the actions the agent can undertake in response to the request, modifying the rules based on the context of the receiver of the request, execution of the request based on the rules, generating a response to the request, or a combination thereof. These functions will be discussed in greater detail below. The request process module 432 can receive the task request 218 from the request initiation module 430. The request process module 432 can generate the recipient response 222. The recipient response 222 can include the recipient information 220.

The notification module 434 is for alerting the sender or receiver of the request regarding information or status of the request. The notification module 434 can alert the request sender 212 or the request recipient 216 with updates related to the task request 218. For example, the notification module 434 can generate a task status notification 440.

The task status notification 440 is a notification that informs the sender or receiver of a request about the status of the request. For example, the task status notification 440 can be a notification that includes the recipient information 220 when the task request 218 has been executed or approved by the sender agent 436. As a specific example, execution or approval of the task request 218 can be when the request receiver device 214 processes the task request 218 to provide the recipient information 220 to the request sender device 210.

In another example, the notification module 434 can generate the task status notification 440 that indicates rejection or denial when the recipient response 222 indicates that the task request 218 has been rejected or denied by the recipient agent 438. As a specific example, rejection or denial of the task request 218 can be when the request receiver device 214 process the task request 218 to withhold or prevent access to the recipient information 220 from the request sender device 210.

The task notification module 434 can generate the task status notification 440, for example, when the request sender device 210 receives the recipient response 222 from the recipient agent 438 of the request receiver device 214. In another example, the notification module 434 can generate the task status notification 440 to alert or notify the request recipient 216 when input or interaction from the request recipient 216 is necessary, such as approving the task request 218 for recipient information 220.

The communication system 100 has been described with module functions or order as an example. It is understood that the modules can be coupled differently. For example, the request initiation module 430 can be coupled to the notification module 434. The communication system 100 can partition the modules differently or order the modules differently. For example, the first control unit 316 can execute the request initiation module 430 and the notification module 434 and the second control unit 388 can execute the request process module 432.

The modules described in this application can be hardware implementation or hardware accelerators in the first control unit 316 of FIG. 3 or in the second control unit 338 of FIG. 3. The modules can also be hardware implementation or hardware accelerators within the first device 102 or the second device 106 but outside of the first control unit 316 or the second control unit 338, respectively.

Referring now to FIG. 5, therein is shown a view of the request process module 432. The request process module 432 can include a request receiver module 550, rule initiation module 552, a rule adjustment module 554, a task execution module 556, and a request response module 558. The request receiver module 550 can be coupled to the rule initiation module 552. The rule initiation module 552 can be coupled to the rule adjustment module 554. The rule adjustment module 554 can be coupled to the task execution module 556. The task execution module 556 can be coupled to the request response module 558.

The request receiver module 550 is for determining the identity of the sender of the request and categorizing the purpose of the request. The request receiver module 550 can determine a sender identifier 560 and a task category 562 for the task request 218. The sender identifier 560 is an identifier for sender of the request. For example, the sender identifier 560 can be an identifier that can associate contact information, such as a phone number or email address, with the request sender 212.

The task category 562 is a categorization or description of the purpose of the request. The task category 562 can be a classification of the purpose of the task request 218, such as whether the task request 218 is for obtaining information or initiating action by the recipient agent 438. As an example, the task category 562 can include different classifications including an informational category for personal information, such as preferences of the request recipient 216, or an action category that can request action by the recipient agent 438, such as a request to change the recipient information 220 or the schedule of the request recipient 216.

The request receiver module 550 can determine the sender identifier 560 and the task category 562 for the task request 218 with a sender identification module 564 and a task classification module 570, respectively.

The sender identification module 564 can determine the sender identifier 560 by comparing an initial contact identifier 566, such as the telephone number or email address transmitted with the task request 218, to entries within a recipient contact list 568 of the request recipient 216. For example, the sender identification module 564 can determine the sender identifier 560 by correlating the contact information specific to a particular individual in the recipient contact list 568 with the initial contact identifier 566. In another example, the sender identification module 564 can determine the sender identifier 560 as an unknown sender when the initial contact identifier 566 does not match an entry in the recipient contact list 568. In a specific example, the request receiver module 550 can prevent further processing of the task request 218 when the sender identifier 560 is generated as the unknown sender.

Optionally, the sender identification module 564 can generate the sender identifier 560. For example, when the sender identifier 560 is determined or generated as the unknown sender, the sender identification module 564 can recipient agent 438 can prompt the request recipient 216 to take specific actions. As a specific example, the recipient agent 438 can prompt the request recipient 216 to generate the sender identifier 560 by manual entry or associating the initial contact identifier 566 with an existing entry in the recipient contact list 568 when the sender identifier 560 is initially determined as the unknown sender.

The task classification module 570 can determine the task category 562 based on a task purpose 572 of the task request 218. For example, when the task purpose 572 is to obtain personal information, such as a preference of the request recipient 216, the task classification module 570 can determine the task category 562 as an informational task. In another example, when the task purpose 572 is to initiate action by the recipient agent 438, the task classification module 570 can determine the task category 562 as an action task. As a specific example, the task classification module 570 can determine the task purpose using text recognition or voice recognition to parse the content of the task request 218.

The rule initiation module 552 is for establishing rules that determine the actions that the agent can undertake in response to the request. The rule initiation module 552 can establish a recipient response rule 574 for responding to the task request 218. The recipient response rule 574 is the rule or guideline that determines the actions the agent can undertake on behalf of the recipient in response to the request. For example, the recipient response rule 574 can determine how the recipient agent 438 can respond to the task request 218. The rule initiation module 552 can establish the recipient response rule 574 based on an accessibility level 576 and a category accessibility 578.

The accessibility level 576 is the degree or level of access granted to the information of the recipient of the request. For example, the accessibility level 576 can be the levels of access that the recipient agent 438 grants the sender agent 436to the recipient information 220.

The accessibility level 576 can be divided to various levels of access for a given category or classification of the recipient information 220. For example, the accessibility level 576 can include a high level of access, a moderate level of access, a low level of access, or no access. The accessibility level 576 can be automatically determined by the communication system 100, based on default settings, explicitly set or determined by the request recipient 216, or a combination thereof.

The high level of the accessibility level 576 can enable the sender agent 436 to directly view and alter or manipulate the recipient information 220 for a given category of the recipient information 220. For example, the recipient agent 438 can execute the task request 218 that can allow the sender agent 436 to adjust the schedule or calendar of the request recipient 216 by adding, changing, or removing appointments. In another example, the recipient agent 438 can execute the task request 218 that allows the sender agent 436 to add, change, or remove information, such as contact information, personal information, or preferences of the request recipient 216 at the high level of the accessibility level 576.

The moderate level of the accessibility level 576 can enable the sender agent 436 to view and access but not alter or manipulate the recipient information 220. For example, the recipient agent 438 can execute the task request 218 that allows the sender agent 436 to view all the entries in the contact list or the calendar on the request receiver device 214, but will not allow the task request 218 for changing the recipient information 220 as with the high level of the accessibility level 576.

The low level of the accessibility level 576 limit the access the sender agent 436 has to the recipient information 220. For example, the recipient agent 438 can reveal only the portions of the recipient information 220 that is requested by the sender agent 436 in the task request 218. As a specific example, when the task request 218 is a request to schedule a meeting with the request recipient 216, the recipient agent 438 can only respond regarding the dates requested in the task request 218 rather than enabling the sender agent 436 to browse the entire calendar of the request recipient 216 as with the moderate level of the accessibility level 576.

The non-accessibility of the accessibility level 576 can enable the recipient agent 438 to block or prevent access of the sender agent 436 to the recipient information 220. For example, the recipient agent 438 can deny or reject any of the task request 218 by the sender agent 436 when the accessibility level 576 is non-accessibility.

For illustrative purposes the communication system 100 is shown having four partitions of the accessibility level 576, however it is understood that the accessibility level 576 can include a different number of partitions. For example, the request recipient 216 can partition the accessibility level 576 to include more or fewer levels of the accessibility level 576.

The category accessibility 578 is a description of the categories of information to which an agent has access. The category accessibility 578 can be based on a privacy level 580 of each category or subcategory of the recipient information 220. For example, the privacy level 580 can include a high privacy level, a moderate privacy level, or a low privacy level.

As a specific example, the high privacy level can be the level of greatest information restriction, such as for identification information, including social security information or credit card numbers, or confidential business information. In another specific example, the moderate privacy level can have a moderate level of restriction, such as for appointment information or contact information for of others. In a further specific example, the low privacy level can have the least amount or no restrictions on information, such as for publicly available information or for preferences of the request recipient 216, such as the favorite color, team, or foods, or recommended restaurants or retail shops. The category accessibility 578 can be automatically determined by the communication system 100, based on default settings, explicitly set or determined by the request recipient 216, or a combination thereof.

For illustrative purposes, the communication system 100 is shown with the category accessibility 578 based on the privacy level 580 having three levels, although it is understood that the privacy level 580 can be partitioned into a different number of levels. For example, the privacy level 580 can have fewer partitions, such as the high privacy level and the low privacy level.

The rule initiation module 552 can determine the recipient response rule 574 based on the accessibility level 576 and the category accessibility 578 by combining the accessibility level 576 for each one of the category accessibility 578. For example, the rule initiation module 552 can enable the request recipient 216 to manually define the recipient response rule 574 that instructing the recipient agent 438 to take specific actions for each combination of the accessibility level 576 and category accessibility 578.

In another example, the rule initiation module 552 can establish default response actions for the recipient response rule 574. More specifically, the rule initiation module 552 can generate the default settings based on information from supplemental sources, such as social networks or through observed communications, such as e-mail, text messages, or telephone conversations.

The rule initiation module 552 can determine the recipient response rule 574 for each entry in the recipient contact list 568. For example, the recipient response rule 574 can be specific to a particular one of the request sender 212 or a class or group of the request sender 212, such as a coworker classification or friend classification.

As a specific example, the rule initiation module 552 can determine the recipient response rule 574 for the request sender 212 associated with a specified group, such as a group of close friends, family, or coworkers. To continue the example, the rule initiation module 552 can determine the recipient response rule 574 such that the recipient agent 438 can approve task request from the request sender 212 associated with the group to view or adjust the recipient information 220 associated with the group.

The rule adjustment module 554 is for dynamic adjustment of the rules that determine the actions that the agent can undertake in response to the request. The rule adjustment module 554 can adjust the recipient response rule 574 based on a recipient context 582. The recipient context 582 are factors pertaining to the recipient of the request for determining a dynamic modification 851 of rules governing access to information of the recipient. The dynamic modification 851 is a change to the rules governing the actions of the agent based on the context of the receiver of the request. For example, the dynamic modification 851 can be changes to the recipient response rule 574 based on the recipient context 582.

The recipient context 582 can be based on various factors or aspects, such as environmental factors, temporal factors, previously learned factors, or events associated with the request recipient 216. The rule adjustment module 554 can check each aspect or factor of the recipient context 582 to determine whether to adjust the recipient response rule 574. The factors or aspects that the recipient context 582 can be based on include an environmental context 584, an event context 586, a learned context 588, a temporal context 590, or a combination thereof. The rule adjustment module 554 can make the dynamic modification 851 to the recipient response rule 754 based on the environmental context 584, the event context 586, the learned context 588, the temporal context 590, or a combination thereof.

The environmental context 584 is the aspect of the recipient context 582 based on the surroundings and location of the request sender 212, request recipient 216, or a combination thereof. For example, the rule adjustment module 554 can make the dynamic modification 851 to the recipient response rule 574 when the location of the request sender 212, request recipient 216 or a combination thereof, is determined to be unsecure or unsafe. As a specific example, the rule adjustment module 554 can temporarily restrict the category accessibility 578 of the sender agent 436 to business related categories of the recipient information 220 when the request sender 212 in the location where competitors can gain access to the recipient information 220, such as a trade show or conference. In another specific example, the rule adjustment module 554 can temporarily lower the accessibility level 576 of the sender agent 436 when it is determined that the request sender 212 is in an unsecure or unsafe location, such as an area of high crime.

The event context 586 is the aspect of the recipient context 582 based on events that are contemporaneously occurring when the task request 218 is sent or received. For example, the rule adjustment module 554 can make the dynamic modification 851 to the recipient response rule 574 for events that can prevent the request recipient 216 from interacting with the recipient agent 438 to approve or review the task request 218. As a specific example, the rule adjustment module 554 can check the calendar of the request recipient 216 for events that can prevent the request recipient 216 or recipient agent 438 from processing the task request 218, such as an airline flight, and automatically lower the accessibility level 576, restrict the category accessibility 578, or a combination thereof, for one or more of the sender agent 436.

The learned context 588 is the aspect of the recipient context 582 based on observed patterns of the request recipient 216. For example, the rule adjustment module 554 can automatically make the dynamic modification 851 to the recipient response rule 574 based on a consistent reaction by the request recipient to an action taken by the recipient agent 438. As a specific example, when the request recipient 216 reverses or overrides an action or decision made by the recipient agent 438, such as a reversal to the schedule of the request recipient 216 by the sender agent 436, the rule adjustment module 554 can lower the accessibility level 576 of the sender agent 436 from the high level to the moderate or low level.

As another specific example, when the request recipient 216 consistently approves or allows the sender agent 436 to access the recipient information 220 for a particular one of the category accessibility 578, the rule adjustment module 554 can allow access of the sender agent 436 for the particular one of the category accessibility 578.

In a further specific example, the rule adjustment module 554 can make the dynamic modification 851 to the recipient response rule 574 based on the learned context 588 when the sender identifier 560 is determined as the unknown sender. For instance, the learned context 588 can include observed actions or patterns by the request recipient 216 when responding to the task request 218 associated with the sender identifier 560 that is the unknown sender. To continue the example, the rule adjustment module 554 can extract or determine behavior patterns of the request recipient 216 from the learned context 588 to determine default or baselines for the recipient response rule 574 for subsequent instances of the sender identifier 560 that are determined as the unknown sender. Optionally, the dynamic modification 851 made to the recipient response rule 574 based on the learned context 588 can be explicitly changed or overridden by request recipient 216.

The temporal context 590 is the aspect of the recipient context 582 based on time. For example, the rule adjustment module 554 can automatically make the dynamic modification 851 to the recipient response rule 574 based on the frequency of the task request 218 from the sender agent 436. As a specific example, when the frequency of the task request 218 from a particular one of the sender agent 436 drops to or below a specific number over a specific period of time, such as when the sender agent 436 does not send the task request 218 in a month, the rule adjustment module 554 can decay or lower the accessibility level 576, remove access to one or more of the category accessibility 578, or a combination thereof, for the particular one of the sender agent 436.

In another example, the rule adjustment module 554 can automatically make the dynamic modification 851 to the recipient response rule 574 based on the time at which the task request 218 was made. For example, when the recipient agent 438 learns that the particular one of the sender agent 436 sends the task request 218 that are consistently rejected by the request recipient 216 at certain times or periods of the day, the rule adjustment module 554 can automatically adjust the recipient response rule 574 to deny accessibility by changing the accessibility level 576, the category accessibility 578, or a combination thereof.

The task execution module 556 is for processing the request according to rules based on accessibility. The task execution module 556 can enable the recipient agent 438 to process or execute the task request 218 according to the recipient response rule 574 associated with the sender agent 436 for the request sender 212. For example, the task execution module 556 can compare the sender identifier 560 and the task category 562 associated the task request 218 to the recipient response rule 574, based on the accessibility level 576 and the category accessibility 578, to determine how the recipient agent 438 should respond the task request 218.

In a specific example, when the task category 562 is for a scheduling action, and the accessibility level 576 is the low level and the category accessibility 578 is the moderate privacy level, associated with the sender identifier 560, the task execution module 556 can enable the recipient agent 438 to process the task request 218 to respond with only dates within the range requested by the task request 218. To continue the example, when the accessibility level 576 is the moderate level, the task execution module 556 can enable the recipient agent 438 to process the task request 218 by allowing the sender agent 436 to view the entire schedule or calendar of the request recipient 216. To further the example, when the accessibility level 576 is the high level, the task execution module 556 can enable the recipient agent 438 to process the task request 218 by allowing the sender agent 436 to view and alter the schedule of the request recipient 216.

In another specific example, when the task category 562 is a request for information, and the accessibility level 576 is the low level and the category accessibility 578 is the low privacy level, which, for example, allows access to preferences of the request recipient 216, associated with the sender identifier 560, the task execution module 556 can enable the recipient agent 438 to provide only the requested portion of the recipient information 220. To continue the example, when the accessibility level 576 is the moderate level, the task execution module 556 can enable the recipient agent 438 to process the task request 218 by allowing the sender agent 436 to view all of the recipient information 220. To further the example, when the accessibility level 576 is the high level, the task execution module 556 can enable the recipient agent 438 to process the task request 218 by allowing the sender agent 436 to view and modify the recipient information 220.

The request response module 558 is for generating a response to a request for a task. The request response module 558 can generate the recipient response 222 based on the output of the task execution module 556. For example, when the recipient response rule 574 enables the recipient agent 438 to process the task request 218, the request response module 558 can generate the recipient response 222 that provides the recipient information 220 to the sender agent 436. In another example, when the recipient response rule 574 does not enable the recipient agent 438 to process the task request 218, the request response module 558 can generate the recipient response 222 that denies the request sender 212 access to the recipient information 220.

The physical transformation from processing the task request 218 by the recipient agent 438 results in the movement in the physical world, such as the request sender 212 using to the recipient information 220, including making purchases or arranging meetings based on the recipient information 220. Movement in the physical world results in changes to the recipient information 220 which in turn further modifies the task request 218 of the request sender 212.

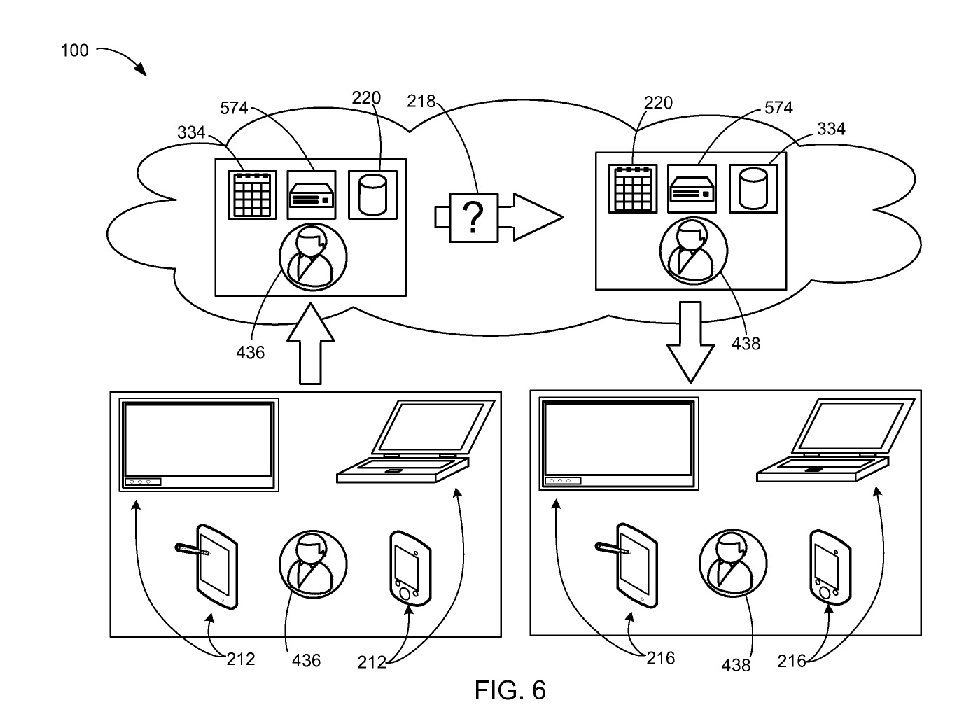

Referring now to FIG. 6, therein is shown an example implementation of the communication system 100. FIG. 6 depicts the sender agent 436 and the recipient agent 438 integrated with multiple instances of the request sender device 210 and the request receiver device 214, respectively. As an example, the recipient agent 438 can be loaded on or integrated with each instance of the request recipient device 214, such as a web-enable television, a tablet personal computer, a laptop, a smart phone, a cellular phone, of a personal digital assistant.

The recipient agent 438 can be integrated with each of the request recipient device 214 to varying degrees. For example, only a portion of the recipient response rule 574 can be included on each instance of the request recipient device 214. As a specific example, the instance of the recipient agent 438 on the second device 106 can be networked the recipient agent 438 on each instance of the request recipient device 214 and can assist in processing the task request 218 with the second control unit 334.

The request sender device 210 can also receive the task request 218 from the request receiver device 214. In the example where the request sender device 210 receives the task request 218, the request sender device 210 can include the recipient information 220, the recipient response rule 574, or a combination thereof.

In another example, the sender agent 436 and the recipient agent 438 can be integrated or loaded on a remote server or cloud storage server, such as the second storage unit 346 of FIG. 3. As a specific example, the instance of the sender agent 436 on the second storage unit 346 can be networked with the sender agent 436 on each instance of the request sender device 210. To continue the example, the interconnection or network between each instance of the sender agent 436 enables the sender agent 436 to determine which instance of the request sender device 210 is currently in use by the request sender 212 or which of the request sender device 210 is in closest proximity to the request sender 212. To further the example, the sender agent 436 can present or display the task status notification 440 of FIG. 4 on the instance of the request sender device 210 that the request sender 212 is currently using or is in closest proximity to. If the request sender 212 acknowledges the task status notification 440, the sender agent 436 can determine that the task status notification 440 has been received by the request sender 212. Otherwise, the sender agent 436 can present or display the task status notification 440 on the next or subsequent instance of the request sender device 210.

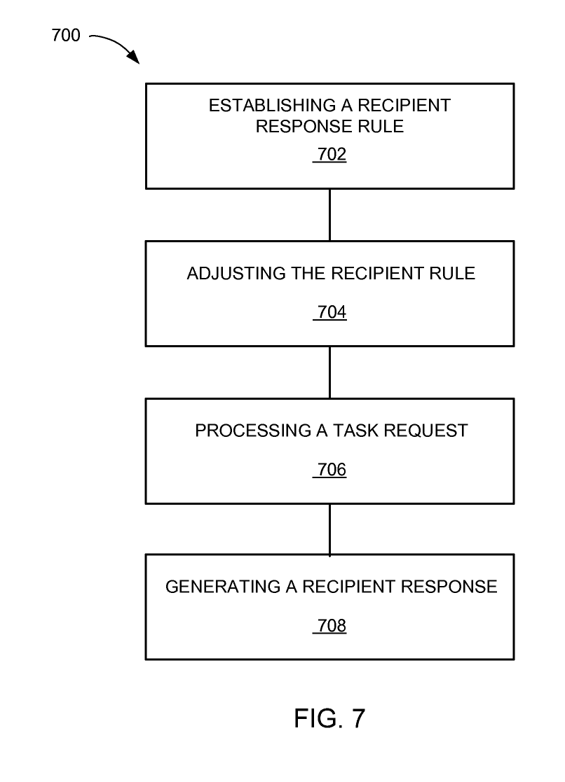

Referring now to FIG. 7, therein is shown a flow chart of a method 600 of operation of a communication system 100 in an embodiment of the present invention. The method 700 includes: establishing a recipient response rule for access to a recipient information with a control unit in a block 702; adjusting the recipient rule based on a recipient context in a block 704; processing a task request to access the recipient information based on the recipient response rule in a block 706; and generating a recipient response to the task request for displaying on a device of the task sender in a block 708.

It has been discovered that the recipient response rule 574 of FIG. 5 provides increased privacy of the request recipient 216 of FIG. 2. The recipient response rule 574, based on the accessibility level 576 of FIG. 5 and the category accessibility level 576, enables the recipient agent 438 of FIG. 4 to selectively restrict access to the recipient information 220 of FIG. 2, which improves security of the request recipient 216.

It has also been discovered that the sender agent 436 of FIG. 4 and the recipient agent 438 provide the advantage of improved efficiency. The sender agent 436 and recipient agent 438 can automatically process the task request 218 of FIG. 2 without interaction with the request recipient 216 which improves efficiency in processing the task request 218.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A communication system comprising:
a rule initiation module configured to establish a recipient response rule for access to a recipient information with a control unit;
a rule adjustment module, coupled to the rule initiation module, configured to adjust the recipient response rule based on a recipient context;
a task execution module, coupled to the rule adjustment module, configured to process a task request to access the recipient information based on the recipient response rule; and
a request response module, coupled to the task execution module, configured to generate a recipient response to the task request for displaying on a device of the request sender.

2. The system as claimed in claim 1 wherein the rule initiation module is configured to establish the recipient response rule based on an accessibility level for a request sender of the task request.

3. The system as claimed in claim 1 wherein the rule initiation module is configured to establish the recipient response rule based on a category accessibility for a request sender of the task request.

4. The system as claimed in claim 1 wherein the rule adjustment module is configured to determine the recipient context based on a learned context for the request recipient of the task request.

5. The system as claimed in claim 1 wherein the rule adjustment module is configured to determine the recipient context based on an environmental context for the request recipient of the task request.

6. The system as claimed in claim 1 wherein further comprising a notification module configured to generate a task status notification based on the recipient response.

7. The system as claimed in claim 6 wherein the rule adjustment module is configured to determine the recipient context based on an event context for the request recipient of the task request.

8. The system as claimed in claim 6 wherein the rule adjustment module is configured to determine the recipient context based on a temporal context for the request recipient of the task request.

9. The system as claimed in claim 6 further comprising a sender identification module, coupled to the rule initiation module, configured to determine a sender identifier of the task request.

10. The system as claimed in claim 6 further comprising a task classification module, coupled to the rule initiation module, configured to determine a task category of the task request.

11. A method of operation of a communication system comprising:
establishing a recipient response rule for access to a recipient information with a control unit;
adjusting the recipient response rule based on a recipient context;
processing a task request to access the recipient information based on the recipient response rule; and
generating a recipient response to the task request for displaying on a device of the request sender.

12. The method as claimed in claim 11 wherein establishing the recipient response rule includes establishing the recipient response rule based on an accessibility level for a request sender of the task request.

13. The method as claimed in claim 11 wherein establishing the recipient response rule includes establishing the recipient response rule based on a category accessibility for a request sender of the task request.

14. The method as claimed in claim 11 further comprising determining the recipient context based on a learned context for the request recipient of the task request.

15. The method as claimed in claim 11 further comprising determining the recipient context based on an environmental context for the request recipient of the task request.

16. A method of operation of a communication system comprising:
establishing a recipient response rule for access to a recipient information with a control unit;
adjusting the recipient response rule based on a recipient context;
processing a task request to access the recipient information based on the recipient response rule;
generating a recipient response to the task request; and
generating a task status notification based on the recipient response for displaying on a device.

17. The method as claimed in claim 16 further comprising determining the recipient context based on an event context for the request recipient of the task request.

18. The method as claimed in claim 16 further comprising determining the recipient context based on a temporal context for the request recipient of the task request.

19. The method as claimed in claim 16 further comprising determining a sender identifier of the task request.

20. The method as claimed in claim 16 further comprising determining a task category of the task request.
